(19) United States
(12) Patent Application Publication
(10) Pub. No.: US 2023/0342566 A1
(43) Pub. Date: Oct. 26, 2023

(54) APPARATUS FOR THE ELECTRONIC RECOGNITION OF A USER

(71) Applicant: BAGGIO GIOVANNI, SAN GIORGIO IN BOSCO (IT)

(72) Inventor: Giovanni BAGGIO, SAN GIORGIO IN BOSCO (IT)

(21) Appl. No.: 18/025,555

(22) PCT Filed: Sep. 1, 2021
(86) PCT No.: PCT/EP2021/074128

§ 371 Date: Mar. 9, 2023

(30) Foreign Application Priority Data
Sep. 24, 2020 (IT) 102020000022510

(51) Int. Cl. G06K 7/10; G06K 19/077

(52) U.S. Cl. CPC G06K 7/10297; G06K 19/07762; G06V 40/13

(57) ABSTRACT

An apparatus for the electronic recognition of a user, which includes an identification element, which can be worn by the user, and an element for reading the identification element and for detecting the user.

### CROSS-REFERENCE TO RELATED APPLICATIONS

This application is a 35 U.S.C. § 371 National Stage patent application of PCT/EP2021/074128 filed 1 Sep. 2021, which claims the benefit of Italian patent application 102020000022510 filed 24 Sep. 2020, the disclosures of which are incorporated herein by reference in their entirety.

### TECHNICAL FIELD

The present disclosure relates to an apparatus for the electronic recognition of a user.

### BACKGROUND

Electronic systems which require user authentication in order to be able to perform some kinds of operations are currently increasingly widespread.

This is the case, for example, of bank payment systems, for which it is necessary to authenticate oneself in order to be able to authorize the payment operation.

Currently, the most secure identification systems, in accordance with EU Directive 2015/2366, known as PSD2, provide for two-step identification by:
entering the credentials of the account in a webpage and/or in a dedicated application of the smartphone,
authorizing the operation by means of tokens via smartphone, which in turn are constituted:
either by SMS,
or by a smartphone application,
   by means of a PIN and/or fingerprint and/or face recognition.

However, this background art has some criticalities.

The need to use a smartphone in current systems may in fact entail risks, as a consequence of theft or loss of said smartphone, due to possible:
easily guessable PINs and/or passwords,
lack of biometric protection (fingerprints and/or face recognition)
failed remote control activation,
lack of anti-virus and/or operating systems that are obsolete or not updated,
use of open (i.e., insecure/unprotected) Wi-Fi networks.

Furthermore, the procedure entails for the user the need to be familiar with the various electronic recognition systems, which vary among the various banking institutions and/or authorizing organizations.

Moreover, sometimes such complexity leads the user to find ways around certain procedures or to configure simplified settings to the detriment of security.

### SUMMARY

The aim of the present disclosure is to provide an apparatus for the electronic recognition of a user that is capable of improving the background art in one or more of the aspects indicated above.

Within this aim, the disclosure provides an apparatus for the electronic recognition of a user that allows user recognition at a higher speed than current known equipment, even without using a smartphone.

the disclosure also provides an apparatus for the electronic recognition of a user that allows user recognition with higher security than similar apparatuses of the known type.

the disclosure further provides an apparatus for the electronic recognition of a user that does not have the absolute need for a smartphone for its operation.

The present disclosure furthermore overcomes the drawbacks of the background art in a manner that is alternative to any existing solutions.

The disclosure also provides an apparatus for the electronic recognition of a user that is highly reliable, relatively easy to provide and at competitive costs.

This aim, as well as these and other advantages which will become better apparent hereinafter, are achieved by providing an apparatus for the electronic recognition of a user, characterized in that it comprises:
an identification element, which can be worn by said user,
an element for reading said identification element and for detecting said user.

### BRIEF DESCRIPTION OF THE DRAWINGS

Further characteristics and advantages of the disclosure will become better apparent from the description of some preferred but not exclusive embodiments of the apparatus for the electronic recognition of a user according to the disclosure, illustrated by way of nonlimiting example in the accompanying drawings, wherein:

FIG. 1 is a side view of a first element of the apparatus for the electronic recognition of a user, according to the disclosure;

FIG. 2 is a top view of the element of FIG. 1;

FIG. 3 is a view of another embodiment or configuration of the first element of FIG. 1;

FIG. 4 is a view of a second element of the apparatus for the electronic recognition of a user according to the disclosure; and

FIG. 5 is a view of the variation of the element of FIG. 4.

### DETAILED DESCRIPTION OF THE DRAWINGS

With reference to the figures, an apparatus for the electronic recognition of a user, according to the disclosure, comprises:
an identification element 11, 111, which can be worn by the user,
an element 12, 112 for reading the identification element 11, 111 and for detecting said user.

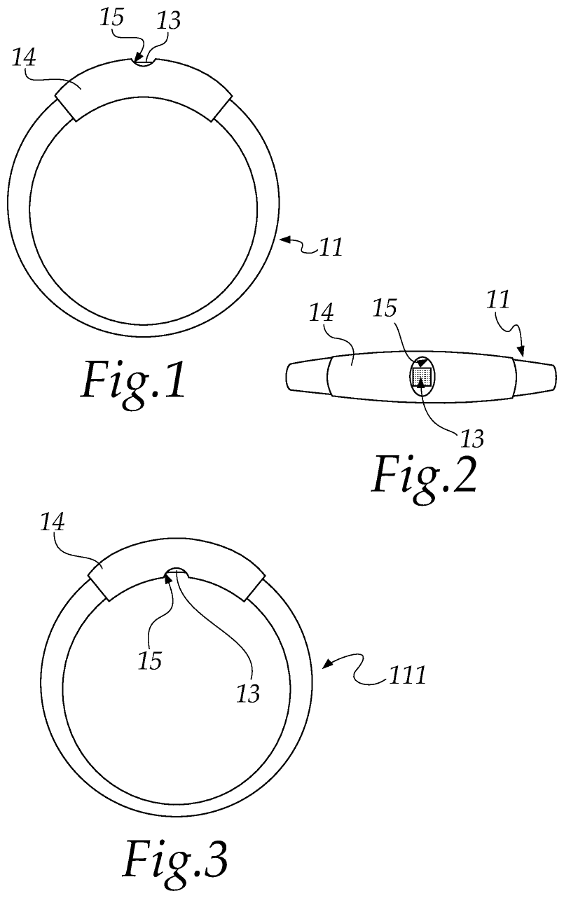

In particular, the identification element 11, 111 is wearable and is constituted for example by a ring, as shown in FIGS. 1 to 3.

However, in other embodiments the identification element 11, 111 is constituted by other types of wearable objects, such as a bracelet and/or a wristwatch.

Such identification element 11, 111 comprises an NFC/RFID (Near-Field Communication/Radio-Frequency Identification) tag 13.

Said NFC/RFID tag 13 is provided with a unique code.

For example, the NFC/RFID tag 13 is of the type of the series known by the commercial name VaultIC of the company WISeKey in Zug (Switzerland).

Preferably, the NFC/RFID tag 13 operates at an ultrahigh frequency (UHF) with wavelengths comprised between 860 MHz and 960 MHz.

The identification element 11, 111 comprises an accommodation portion 14, provided with a seat 15 for the tag 13.

One particularity of the disclosure resides in that the element 12, 112 for reading the identification element 11, 111 and for detecting the user comprises:
means 16 for reading the tag 13 (and therefore its unique code)
and means 17 for reading at least one biometric characteristic of the user.

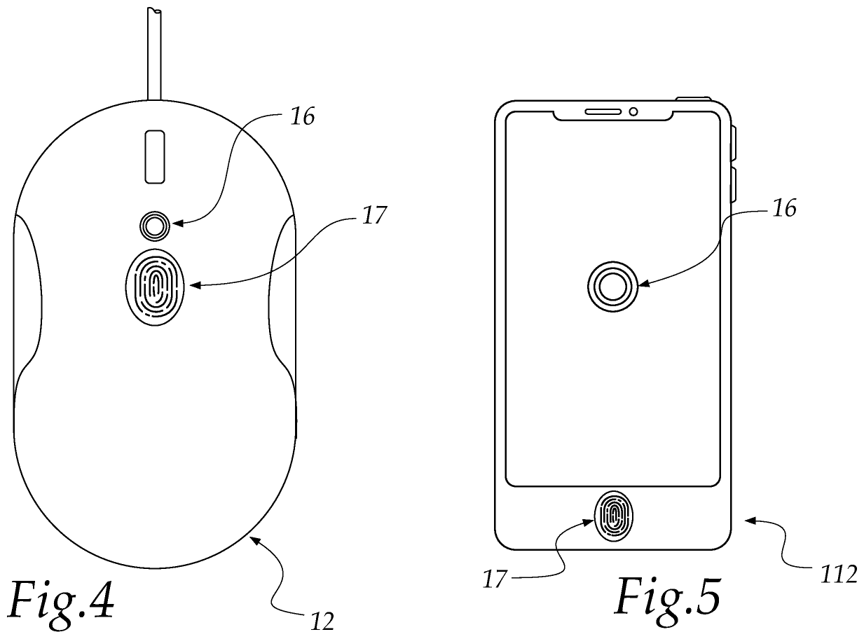

In the example shown in FIG. 4, the element 12 is a mouse and the means 17 for reading at least one biometric characteristic are constituted by a fingerprint reader.

In the example shown in FIG. 5, instead, the element 112 is a smartphone and the means 17 for reading at least one biometric characteristic are constituted, in this case also, by a fingerprint reader.

In other embodiments, not shown in the figures, the element for reading the identification element 11, 111 and for detecting the user is of another type, for example a payment terminal and/or a module which is integrated directly in the keyboard of a portable PC, or others.

Moreover, in other embodiments, not shown in the figures, the element 12, 112 for reading the identification element 11, 111 and for detecting the user can comprise means 17 for also reading other biometric characteristics of the user, such as for example the face and/or the iris.

In this case, the means 17 for reading biometric characteristics comprise face recognition and/or iris recognition means.

The operation of the electronic identification apparatus according to the disclosure is as follows.

First of all, the element 12, 112 for reading the identification element 11, 111 and for detecting the user is enabled to operate on the desired platform, such as a payment system of a credit institution or a platform of another organization.

The element 12, 112 for reading the identification element 11, 111 and for detecting the user is enabled by registering its MAC (Media Access Control) address, which is unique.

Furthermore, the element 12, 112 for reading the identification element 11, 111 and for detecting the user is configured so that:
the means 16 for reading the tag 13 are capable of recognizing the tag 13 (and its unique code) contained in the identification element 11, 111,
the means 17 for reading the biometric characteristics of the user are capable of recognizing these characteristics (for example by registering the fingerprint of the user and/or the image of his face and/or of his iris).

When the user needs to authorize an operation, such as for example a payment, he uses the element 12, 112 for reading the identification element 11, 111 and for detecting the user, who is enabled to operate on the platform of the credit institution and identifies himself by means of the unique reading:
of his preset biometric characteristics, via the means 17 for reading the biometric characteristics of the element 12, 112 for reading the identification element 11, 111 and for detecting the user,
of the tag 13 contained in the identification element 11, 111, via the means 16 for reading the tag 13.

It should be noted that the element 12, 112 for reading the identification element 11, 111 and for detecting the user is uniquely associated:
with the biometric characteristics,
with the tag 13 contained in the identification element 11, 111, of a specific user.

Accordingly, no other user can be identified and can thus authorize operations on a given platform by means of that element 12, 112 for reading the identification element 11, 111 and for detecting the user and/or that identification element 11, 111.

However, the element 12, 112 for reading the identification element 11, 111 and for detecting the user can also be associated with multiple users, so that for each individual user it is capable of detecting the unique combination between his biometric characteristics and his identification element 11, 111.

In this manner, with the same element for reading the identification element 11, 111 and for detecting the user, for example a payment terminal not shown in the figures, it is possible to identify multiple users and allow them to perform operations securely.

In this case, the element for reading the identification element and for detecting the user allows to authorize a given operation only if and when it detects the unique combination between the biometric characteristics and the identification element 11, 111 of a given registered user.

It should also be noted that since the identification element 11, 111 is wearable by the user, it is much more secure than current tokens which require a smartphone, which has a higher risk of theft or loss since it is not wearable.

Furthermore, it should be noted that with the apparatus according to the disclosure the user does not need to memorize different procedures and/or access codes for the various platforms of the various credit institutions or other organizations but a single apparatus for each platform is sufficient for him.

Moreover, it should be noted that with the apparatus according to the disclosure it is possible to associate with each element 11, 111 a photograph of the user and said photograph can be revealed/shown on an interface which is available to a third party after the reading of the element 11, 111 and of the fingerprint in order to allow said third party to identify a person/user visually as well.

In practice it has been found that the disclosure achieves the intended aim and objects, providing an apparatus for the electronic recognition of a user that allows user recognition at a higher speed than current known apparatuses, but also without the need for a smartphone.

The disclosure provides an apparatus for the electronic recognition of a user which allows user recognition with greater security than similar apparatuses of the known type.

Furthermore, the disclosure provides an apparatus for the electronic recognition of a user which does not require a smartphone for its operation.

The disclosure thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

1-10. (canceled)

11. An apparatus for the electronic recognition of a user, comprising:
an identification element configured to be worn by said user, and
a reading element configured for reading said identification element and for detecting said user.

12. The apparatus according to claim 11, wherein said identification element comprises an NFC/RFID tag.

13. The apparatus according to claim 12, wherein said reading element comprises:
reading means configured for reading said NFC/RFID tag, and
reading means configured for reading at least one biometric characteristic of the user.

14. The apparatus according to claim 12, wherein said NFC/RFID tag is of of a series having the commercial name VaultIC of the company WISeKey in Zug.

15. The apparatus according to claim 12, wherein said NFC/RFID tag operates at an ultrahigh frequency with wavelengths comprised between 860 MHz and 960 MHz.

16. The apparatus according to claim 11, wherein said identification element is selectively chosen from the group consisting of a ring, a bracelet, and a wristwatch.

17. The apparatus according to claim 11, wherein said identification element comprises an accommodation portion, which is provided with a seat for said tag.

18. The apparatus according to claim 11, wherein said reading means for reading at least one biometric characteristic comprise a fingerprint reader.

19. The apparatus according to claim 11, wherein said reading means for reading at least one biometric characteristic comprise face recognition means and/or iris recognition means.

20. The apparatus according to claim 11, wherein said reading element is selectively chosen from the group consisting of a mouse, a smartphone, a payment terminal, and a module integrated in the keyboard of a portable PC.
